(19) United States
(12) Patent Application Publication
(10) Pub. No.: US 2023/0034515 A1
(43) Pub. Date: Feb. 2, 2023

(54) INFERENCE DEVICE, AND UPDATE METHOD

(71) Applicant: Mitsubishi Electric Corporation, Tokyo (JP)

(72) Inventors: Koji TANAKA, Tokyo (JP); Katsuki KOBAYASHI, Tokyo (JP); Yusuke KOJI, Tokyo (JP)

(73) Assignee: Mitsubishi Electric Corporation, Tokyo (JP)

(21) Appl. No.: 17/965,995

(22) Filed: Oct. 14, 2022

Related U.S. Application Data
(63) Continuation of application No. PCT/JP2020/020077, filed on May 21, 2020.

(51) Int. Cl. G06N 5/04

(52) U.S. Cl. CPC G06N 5/04

(57) ABSTRACT

An inference device includes a first acquisition unit that acquires first input information, a storage unit that stores a knowledge graph, an inference execution unit that executes the inference based on the knowledge graph, an output unit that outputs information, a second acquisition unit that acquires second input information indicating a user's intention in regard to the result of the inference and including a first word, and a control unit that judges whether the result of the inference is appropriate or not based on the information based on the result of the inference and the second input information, and when the result of the inference is inappropriate, determines a node of the first word among the plurality of nodes, adds an AND node to the knowledge graph, and associates an inference start node and the node of the first word with each other via the AND node.

### CROSS-REFERENCE TO RELATED APPLICATION

This application is a continuation application of International Application No. PCT/JP2020/020077 having an international filing date of May 21, 2020.

### BACKGROUND OF THE INVENTION

### 1. Field of the Invention

The present disclosure relates to an inference device, and an update method.

### 2. Description of the Related Art

Devices equipped with a Human Machine Interface (HMI) of the dialog type are widespread. For example, such devices include car navigation systems, household electric appliances, smart speakers and so forth. To realize the dialog with the device, a scenario is designed based on a state chart, a flowchart or the like. However, it is difficult to design complicated and diversified dialogs and dialogs that are perceived as being thoughtful.

In such a circumstance, there has been proposed an inference device that realizes the dialog by means of inference based on a knowledge graph (see Patent Reference 1). The knowledge graph is a knowledge representation representing properties of things, relevance among things, causal relationship or the like in the form of a graph. The inference device derives a result of inference by specifying a node representing an observed fact as a starting point and using an importance level of each node in the knowledge graph. Then, a response based on the result of the inference is outputted. For example, a knowledge “eat cold food” is inferred from an observed fact “hot” and an observed fact “lunchtime” acquired from sensor information. Then, a response “It's hot and it's lunchtime, so wound you like to eat cold food?” is outputted. As above, by using the knowledge graph, the need of generating a complicated scenario is eliminated.
Patent Reference 1: Japanese Patent No. 6567218
Non-patent Reference 1: L. Page, S. Brin, R. Motwani, and T. Winograd, “The Pagerank Citation Ranking: Bringing Order to the Web”, 1999

In the above-described technology, the inference is made with reliance on the way of selecting the node as the starting point and the structure of the knowledge graph. Accordingly, there can be cases where a desirable inference result cannot be obtained.

### SUMMARY OF THE INVENTION

An object of the present disclosure is to make it possible to obtain a desirable inference result.

An inference device according to an aspect of the present disclosure is provided. The inference device includes a first acquisition unit that acquires first input information, a storage unit that stores a knowledge graph including a plurality of nodes corresponding to a plurality of words, an inference execution unit that executes the inference based on the knowledge graph as a node based on the first input information among the plurality of nodes being an inference start node where inference is started, an output unit that outputs information based on a result of the inference, a second acquisition unit that acquires second input information indicating a user's intention in regard to the result of the inference and including a first word, and a control unit that judges whether the result of the inference is appropriate or not based on the information based on the result of the inference and the second input information, and when the result of the inference is inappropriate, determines a node of the first word among the plurality of nodes, adds a first node to the knowledge graph, and associates the inference start node and the node of the first word with each other via the first node.

According to the present disclosure, a desirable inference result can be obtained.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing an example of a communication system;

FIG. 2 is a diagram showing hardware included in an inference device;

FIG. 3 is a diagram for explaining an inference execution unit in detail;

FIG. 4 is a diagram showing a concrete example of an inference process;

FIG. 5 is a flowchart showing an example of a process executed by the inference device;

FIG. 6 is a flowchart showing an example of the inference process;

FIG. 7 is a diagram showing an example of update of page rank values;

FIG. 8 is a flowchart showing an example of an update process; and

FIG. 9 is a diagram showing a concrete example of the update process.

### DETAILED DESCRIPTION OF THE INVENTION

An embodiment will be described below with reference to the drawings. The following embodiment is just an example and a variety of modifications are possible within the scope of the present disclosure.

### Embodiment

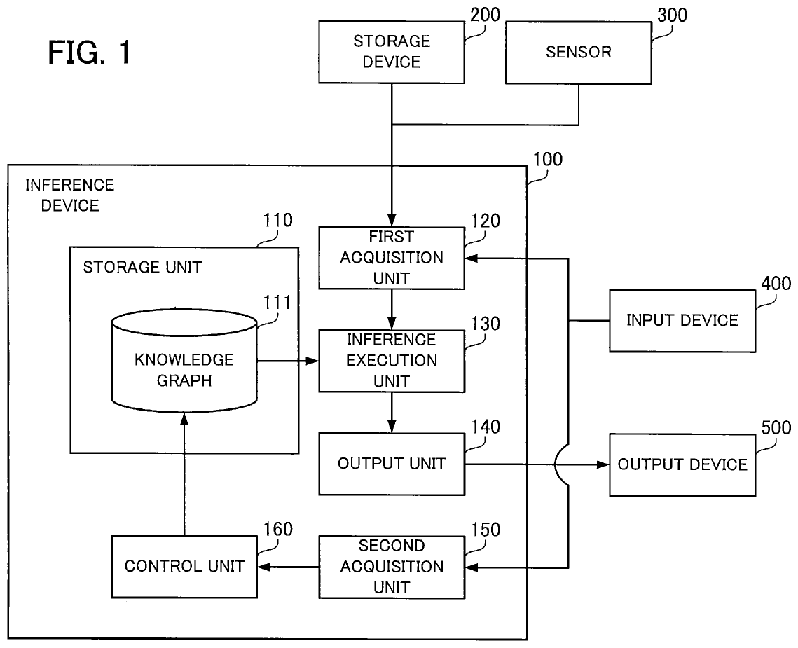

FIG. 1 is a diagram showing an example of a communication system. The communication system includes an inference device 100, a storage device 200, a sensor 300, an input device 400 and an output device 500.

The inference device 100 connects to the storage device 200, the sensor 300, the input device 400 and the output device 500 via a network. For example, the network is a wired network or a wireless network.

The inference device 100 is a device that executes an update method.

The storage device 200 is a device that stores a variety of information. For example, the storage device 200 stores time information such as the current season, day of the week and time of day, navigation information indicating the present position, traffic information, weather information, news information, and profile information indicating a user's schedule, preference and so forth.

The sensor 300 is a sensor that senses the user's condition or vicinal situation. For example, the sensor 300 is a wearable sensor.

For example, the input device 400 is a camera or a microphone. Incidentally, the microphone will be referred to as a mic. For example, when the input device 400 is a camera, an image obtained by the camera by photographing is inputted to the inference device 100. For example, when the input device 400 is a mic, voice information outputted from the mic is inputted to the inference device 100. The input device 400 may input information to the inference device 100 according to an operation performed by the user.

The inference device 100 is capable of acquiring information from the storage device 200, the sensor 300 and the input device 400. The information may include vehicle information such as a vehicle speed and an angle of a steering wheel.

For example, the output device 500 is a speaker or a display. Incidentally, the input device 400 and the output device 500 may be included in the inference device 100.

Here, hardware included in the inference device 100 will be described below.

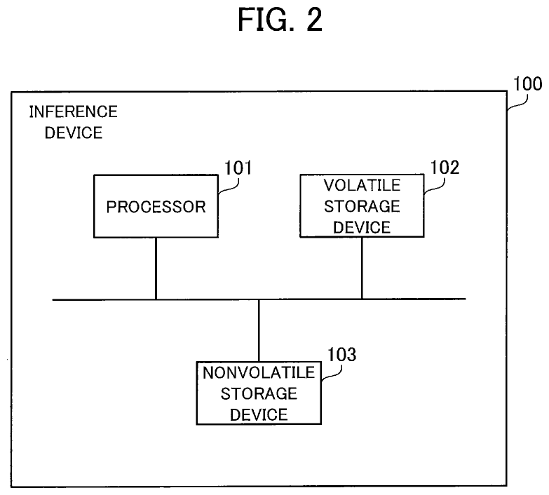

FIG. 2 is a diagram showing the hardware included in the inference device. The inference device 100 includes a processor 101, a volatile storage device 102 and a nonvolatile storage device 103.

The processor 101 controls the whole of the inference device 100. For example, the processor 101 is a Central Processing Unit (CPU), a Graphics Processing Unit (GPU), a Field Programmable Gate Array (FPGA) or the like. The processor 101 can also be a multiprocessor. The inference device 100 may include a processing circuitry instead of the processor 101. The processing circuitry may be either a single circuit or a combined circuit.

The volatile storage device 102 is main storage of the inference device 100. The volatile storage device 102 is a Random Access Memory (RAM), for example. The nonvolatile storage device 103 is auxiliary storage of the inference device 100. The nonvolatile storage device 103 is a Hard Disk Drive (HDD) or a Solid State Drive (SSD), for example.

Returning to FIG. 1, functions of the inference device 100 will be described below.

The inference device 100 includes a storage unit 110, a first acquisition unit 120, an inference execution unit 130, an output unit 140, a second acquisition unit 150 and a control unit 160. Incidentally, the control unit 160 may be referred to also as an update unit.

The storage unit 110 may be implemented as a storage area reserved in the volatile storage device 102 or the nonvolatile storage device 103.

Part or all of the first acquisition unit 120, the inference execution unit 130, the output unit 140, the second acquisition unit 150 and the control unit 160 may be implemented by a processing circuitry. Part or all of the first acquisition unit 120, the inference execution unit 130, the output unit 140, the second acquisition unit 150 and the control unit 160 may be implemented as modules of a program executed by the processor 101. For example, the program executed by the processor 101 is referred to also as an update program. The update program has been recorded in a record medium, for example.

The storage unit 110 stores a knowledge graph 111. The knowledge graph 111 holds information necessary for the inference. In general, the knowledge graph 111 is a relational database that holds information in various domains in a graph format. For example, Resource Description Framework (RDF) is used as the graph format. In RDF, information is represented by a triplet (a set of three), a predicate and an object. For example, information “it is Friday today” is represented as a triplet (today, day of the week, Friday).

The first acquisition unit 120 is capable of acquiring information from the storage device 200, the sensor 300 and the input device 400. Here, this information is referred to as first input information.

The inference execution unit 130 executes the inference based on the first input information and the knowledge graph 111. For example, the inference process is an inference process described in the Patent Reference 1. Here, the inference execution unit 130 will be described in detail below.

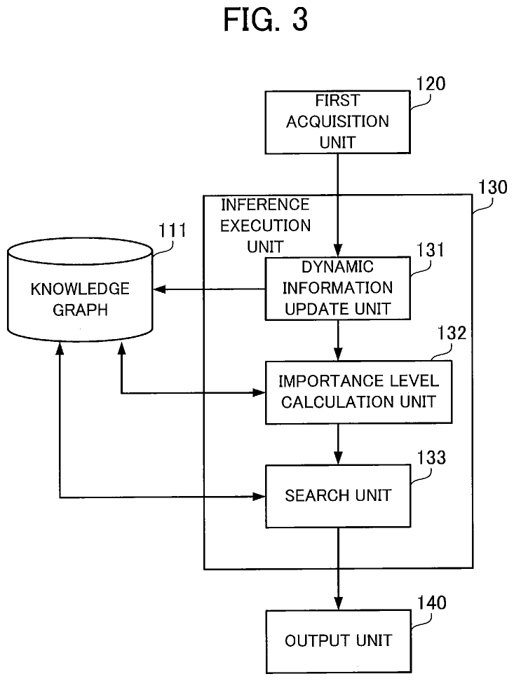

FIG. 3 is a diagram for explaining the inference execution unit in detail. The inference execution unit 130 includes a dynamic information update unit 131, an importance level calculation unit 132 and a search unit 133.

The dynamic information update unit 131 updates the knowledge graph 111 based on the first input information. Incidentally, the dynamic information update unit 131 does not update the knowledge graph 111 when contents indicating the first input information have already been registered in the knowledge graph 111 as will be described later.

The importance level calculation unit 132 specifies a node based on the first input information among a plurality of nodes as an inference start node where the inference is started. Here, the node based on the first input information will be described below. First, the first input information may include input words as one or more words. Each of the one or more words can be a word such as a noun, an adjective or the like. When a node of an input word is added to the knowledge graph 111 by the dynamic information update unit 131, the node based on the first input information is the node of the input word. When a node of an input word has already been registered in the knowledge graph 111, the node based on the first input information is the node of the input word. Further, when a node of a word obtained based on the first input information is added to the knowledge graph 111 by the dynamic information update unit 131, the node based on the first input information is the node of the word obtained based on the first input information. When a node of a word obtained based on the first input information has already been registered in the knowledge graph 111, the node based on the first input information is the node of the word obtained based on the first input information. Here, the word obtained based on the first input information will be described below. For example, when the first input information indicates the present time “17:24”, the word obtained based on the first input information is “evening”.

The importance level calculation unit 132 executes a random walk by specifying the inference start node as the starting point and calculates a page rank value, as a value corresponding to the importance level of each node in the knowledge graph 111. Incidentally, when an AND node which will be described later is included in the knowledge graph 111, the importance level calculation unit 132 uses page rank calculation algorithm that is employed a fuzzy operation.

The search unit 133 searches the knowledge graph 111 for a node corresponding to a triplet having a pattern coinciding with a query. The search unit 133 sorts the nodes found by the search based on the page rank values associated with the nodes found by the search. The search unit 133 determines a node having the highest page rank value as an inference result. Alternatively, the search unit 133 may determine a plurality of nodes having high page rank values as the inference result.

Here, a description will be given of an example of a case where a recommended restaurant is proposed to a driver driving an automobile. Incidentally, the proposal is assumed to propose a hamburger shop.

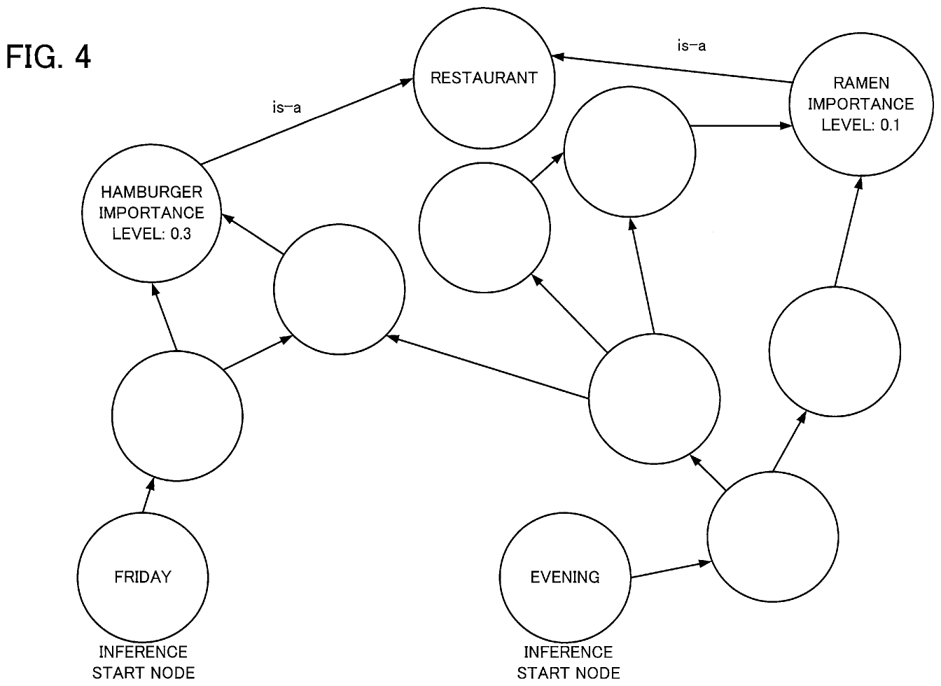

FIG. 4 is a diagram showing a concrete example of the inference process. First, the first acquisition unit 120 acquires time information as the first input information. The time information indicates Friday evening. Further, FIG. 4 indicates that the knowledge graph 111 includes a plurality of nodes corresponding to a plurality of words. For example, FIG. 4 indicates that the knowledge graph 111 includes a node corresponding to “hamburger” and a node corresponding to “ramen”.

The dynamic information update unit 131 adds a node “Friday” and a node “evening” to the knowledge graph 111. Incidentally, when the node “Friday” and the node “evening” have already been registered in the knowledge graph 111, the dynamic information update unit 131 does not add the node “Friday” and the node “evening”. The importance level calculation unit 132 specifies the node “Friday” and the node “evening” as inference start nodes and calculates the page rank value of each node. The search unit 133 searches the knowledge graph 111 for a node corresponding to a triplet having a pattern coinciding with the query. By this search, the node “hamburger” and the node “ramen” are found. The search unit 133 sorts the nodes found by the search based on the page rank values associated with the nodes found by the search. The search unit 133 determines the node “hamburger”, being a node linked to an edge “is-a” connected to the node “restaurant” and having the highest page rank value, as the inference result.

Returning to FIG. 1, the output unit 140 will be described below.

The output unit 140 outputs information based on the inference result to the output device 500. In the case of FIG. 4, for example, the output unit 140 outputs information “Would you like to eat a hamburger?” to the output device 500. Accordingly, in the case where the output device 500 is a speaker, for example, the output device 500 outputs the information “Would you like to eat a hamburger?” by voice.

The second acquisition unit 150 acquires information indicating the user's intention in regard to the inference result. The information indicating the user's intention will be described specifically below. The driver described with reference to FIG. 4 usually eats a hamburger. However, the driver has a habit of eating ramen Friday evening. Therefore, in response to the inference result, the driver utters “No, I'd like to eat not a hamburger but ramen.”. For example, the second acquisition unit 150 acquires the information indicating the user's intention as the driver's utterance via the input device 400. Accordingly, the inference device 100 learns that it is desirable to determine the node “ramen” as the inference result rather than determining the node “hamburger” as the inference result in the case where the input information “Friday evening” is acquired. Incidentally, the node as the inference result will hereinafter be referred to as a prediction node. In FIG. 4, for example, the node “hamburger” is the prediction node. Further, a node that is desirable as the inference result will be referred to as a target node or a target node T. In FIG. 4, for example, the node “ramen” is the target node.

The control unit 160 updates the knowledge graph 111 based on the information indicating the user's intention. Specifically, the control unit 160 adds an AND node to the knowledge graph 111. In FIG. 4, for example, the control unit 160 adds (Friday, eat, AND), (evening, eat, AND) and (AND, eat, ramen) to the knowledge graph 111. Accordingly, the node “ramen” is inferred in the next inference.

Next, a process executed by the inference device 100 will be described below by using a flowchart.

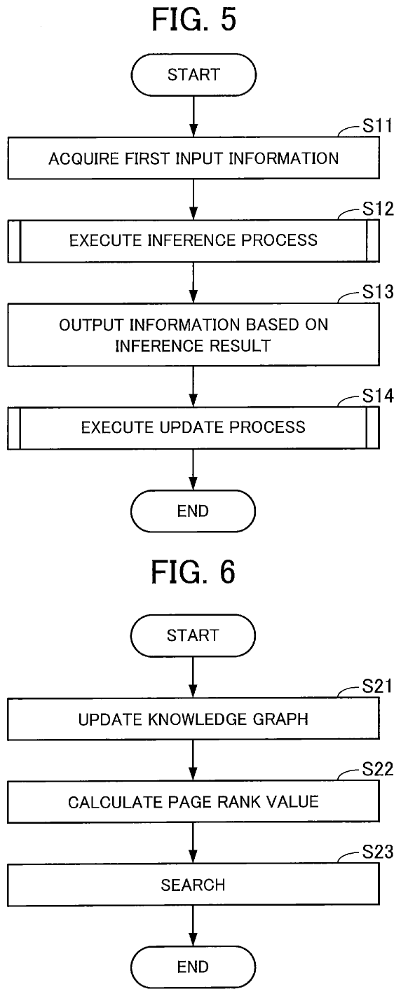

FIG. 5 is a flowchart showing an example of the process executed by the inference device.

(Step S11) The first acquisition unit 120 acquires the first input information.

(Step S12) The inference execution unit 130 executes the inference process based on the first input information and the knowledge graph 111.

(Step S13) The output unit 140 outputs the information based on the inference result to the output device 500. For example, the output unit 140 outputs the information “Would you like to eat a hamburger?” to the output device 500.

(Step S14) The inference device 100 executes an update process.

FIG. 6 is a flowchart showing an example of the inference process. The process of FIG. 6 corresponds to the step S12.

(Step S21) The dynamic information update unit 131 updates the knowledge graph 111 based on the first input information. For example, when the first input information indicates that the present time is “17:24”, the dynamic information update unit 131 adds a triplet (present time, value, 17:24) to the knowledge graph 111. Further, for example, when there is a rule “add a triplet (present, time slot, evening) if x in a query “present time, value, ?x” is between 16:00 and 18:00”, the dynamic information update unit 131 adds the triplet (present, time slot, evening) to the knowledge graph 111.

(Step S22) The importance level calculation unit 132 executes a random walk by specifying the inference start node as the starting point and calculates the page rank value, as the value corresponding to the importance level of each node in the knowledge graph 111. As the method of calculating the page rank value, a plurality of methods have been proposed. For example, an iteration method has been proposed. In the iteration method, a page rank initial value is provided to each node. A page rank value is exchanged between nodes connected by an edge until the page rank values converge. Further, a page rank value at a certain ratio is supplied to the inference start node. Incidentally, the iteration method is described in Non-patent Reference 1.

Here, when an AND node is included in the knowledge graph 111, the importance level calculation unit 132 uses page rank calculation algorithm that is employed the fuzzy operation. In other words, when the inference start node and the target node have already been associated with each other via an AND node and the page rank values of a plurality of nodes including the AND node are updated, the importance level calculation unit 132 uses page rank calculation algorithm that is employed the fuzzy operation.

In the page rank calculation algorithm that is employed the fuzzy operation, the update method of the page rank values in the vicinity of the AND node has a characteristic. Incidentally, the vicinity of the AND node means the AND node and nodes connected to the AND node via an edge. In general, in a proposition “A AND B” using the logical product (AND), when both of A and B are true (1) at the same time, this proposition is also true (1). The fuzzy operation is an operation designed to be able to handle ambiguity by expanding a logical operation capable of handling only two values: true (1) and false (0) so as to be able to handle continuous values, in which the logical product is defined as an operation of taking a minimum value. For example, when the degree that A is true is 0.1 (i.e., substantially false) and the degree that B is true is 0.8 (i.e., substantially true), the proposition “A AND B” takes on a value 0.1 (=min (0.1, 0.8)). Then, it is interpreted as being substantially false. Such a fuzzy operation is employed for the page rank calculation algorithm. Then, in the update process of the page rank values of the nodes in the vicinity of the AND node, a page rank amount flows into the AND node based on the minimum value of the page rank amounts. Further, page rank amounts other than the minimum value are supplied to the inference start node.

Next, the page rank calculation algorithm that is employed the fuzzy operation will be described specifically below.

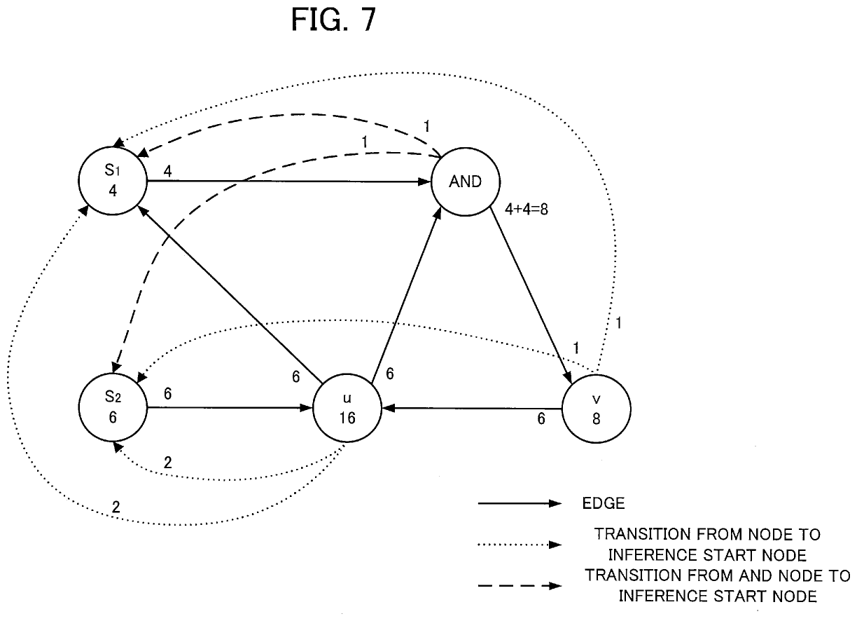

FIG. 7 is a diagram showing an example of the update of the page rank values. FIG. 7 shows nodes S₁, S₂, u and v. Incidentally, the nodes S₁ and S₂ are the inference start nodes. Further, FIG. 7 shows an AND node. Each solid line arrow indicates an edge. Incidentally, the vicinity of the AND node represents the AND node and the nodes S₁, u and v. Further, the node S₁ and the node u are referred to also as a plurality of second nodes.

The number in each node indicates the page rank value in a certain step in the calculation by means of the iteration method. The number in the vicinity of an arrow represents the page rank amount that is exchanged in the next step. Each dotted line arrow indicates a random transition to an inference start node. The random transition occurs at a certain probability.

The importance level calculation unit 132 determines the minimum value out of a plurality of page rank amounts supplied to the AND node from the node S₁ and the node u connected via an edge. For example, the importance level calculation unit 132 determines the page rank amount “4” out of the page rank amount “4” and the page rank amount “6”. The importance level calculation unit 132 limits the page rank amount supplied to the AND node from each of the node S₁ and the node u not to exceed the minimum value. Accordingly, the page rank amount from the node u is limited within “4”. Then, the page rank amount “4” from the node S₁ and the page rank amount “4” from the node u flow into the AND node. The page rank amount “8” flows out of the AND node. The importance level calculation unit 132 performs the limitation in regard to the node u and thereby by which the page rank amount “2 (=6−4)” is left over. The importance level calculation unit 132 supplies the remaining page rank amount “2” to the nodes S₁ and S₂. The broken line arrows indicate that the remaining page rank amount is supplied to the nodes S₁ and S₂. As above, the importance level calculation unit 132 supplies the page rank amount “2”, not supplied to the AND node out of the plurality of page rank amounts, to the nodes S₁ and S₂.

By this process, the importance level calculation unit 132 is capable of keeping the sum total of the page rank values of all the nodes constant. Further, by keeping the sum total of the page rank values of all the nodes constant, the importance level calculation unit 132 is capable of appropriately converging the page rank values. Specifically, the importance level calculation unit 132 repeats the update of the page rank values of all the nodes until the page rank values of all the nodes stop changing. In other words, the importance level calculation unit 132 repeats the update of the page rank values of all the nodes until the page rank values of all the nodes converge. The page rank values at the time of the convergence constitute a calculation result of the page rank values. Here, if the sum total of the page rank values of all the nodes are not kept constant, there is a possibility that the page rank values do not converge appropriately. If the sum total of the page rank values of all the nodes are not kept constant, disappearance of a page rank amount occurs repeatedly in the course of the update iteration process. Then, the page rank amount eventually decreases to zero. Accordingly, the calculation result “the page rank value is zero at all the nodes” is obtained. Namely, the page rank values do not converge appropriately. To prevent this error, the importance level calculation unit 132 executes the above-described process. By this process, the importance level calculation unit 132 is capable of keeping the sum total of the page rank values of all the nodes constant.

(Step S23) The search unit 133 searches the knowledge graph 111 for a node corresponding to a triplet having a pattern coinciding with the query. The search unit 133 sorts the nodes found by the search based on the page rank values associated with the nodes found by the search. The search unit 133 determines the node having the highest page rank value as the inference result.

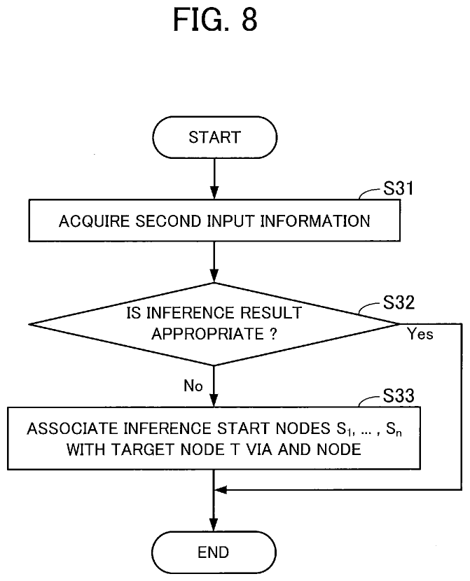

FIG. 8 is a flowchart showing an example of the update process. The process of FIG. 8 corresponds to the step S14.

(Step S31) The second acquisition unit 150 acquires the information indicating the user's intention in regard to the inference result. The information indicating the user's intention in regard to the inference result is referred to as second input information. The second input information may be referred to also as feedback information. For example, the second acquisition unit 150 acquires second input information “No, I'd like to eat ramen.”. Here, the second input information includes a first word. The first word is a word such as a noun, an adjective or the like. For example, the first word is “ramen” in “No, I'd like to eat ramen.”.

(Step S32) The control unit 160 judges whether the inference result is appropriate or not based on the information based on the inference result and the second input information.

The judgment process will be described specifically below. For example, the information based on the inference result is the information “Would you like to eat a hamburger?”. The second input information is the information “No, I'd like to eat ramen.”. The control unit 160 compares a word (e.g., hamburger) included in the information based on the inference result with a word (e.g., ramen) included in the second input information. When the compared words do not coincide with each other, the control unit 160 judges that the inference result is inappropriate.

When the inference result is inappropriate, the control unit 160 judges that the knowledge graph 111 should be updated. Then, the control unit 160 advances the process to step S33. When the inference result is appropriate, the control unit 160 ends the process.

(Step S33) The control unit 160 determines the target node T among the plurality of nodes included in the knowledge graph 111 based on the second input information. For example, the control unit 160 determines a node of the first word (e.g., ramen) included in the second input information as the target node T. The control unit 160 associates the inference start nodes S₁, Sn with the target node T via the AND node. The update process will be described below by using a concrete example.

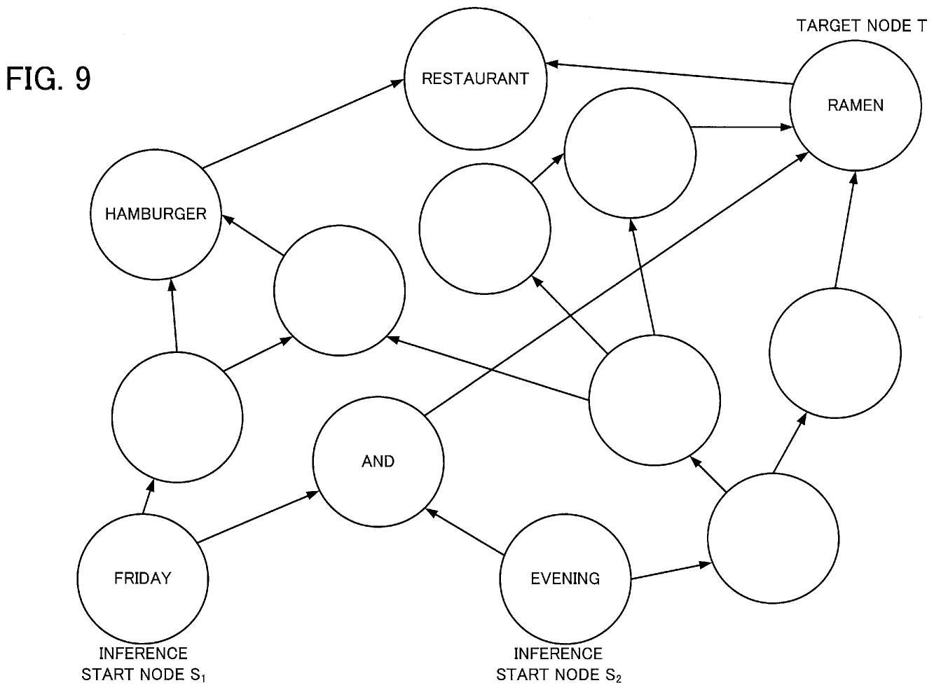

FIG. 9 is a diagram showing a concrete example of the update process. The control unit 160 adds an AND node to the knowledge graph 111. Here, the AND node is referred to also as a first node.

The control unit 160 generates a directed edge between the inference start node S₁ and the AND node. The control unit 160 generates a directed edge between the inference start node S₂ and the AND node. The control unit 160 generates a directed edge between the AND node and the target node T. As above, the control unit 160 generates a path via the AND node between each inference start node S₁, S₂ and the target node T. Accordingly, the node “ramen” is inferred in the next inference.

Here, the reason why the node “ramen” is inferred in the next inference will be explained below. To each inference start node S₁, S₂, page rank amounts are supplied from all the nodes. Therefore, the page rank value of each inference start node S₁, S₂ is large. Accordingly, the page rank amount flowing out of each inference start node S₁, S₂ is also large. Then, a great page rank amount flows into the target node T via the AND node. Therefore, the page rank value of the target node T becomes large. In other words, the importance level of the target node T becomes high. Accordingly, the node “ramen” is inferred.

According to the embodiment, the inference device 100 updates the knowledge graph 111 and thereby infers the node “ramen” in the next inference, for example. Accordingly, the inference device 100 is capable of obtaining a desirable inference result.

### DESCRIPTION OF REFERENCE CHARACTERS

100: inference device, 101: processor, 102: volatile storage device, 103: nonvolatile storage device, 110: storage unit, 111: knowledge graph, 120: first acquisition unit, 130: inference execution unit, 131: dynamic information update unit, 132: importance level calculation unit, 133: search unit, 140: output unit, 150: second acquisition unit, 160: control unit, 200: storage device, 300: sensor, 400: input device, 500: output device

What is claimed is:

1. An inference device comprising:
a first acquiring circuitry to acquire first input information;
a memory to store a knowledge graph including a plurality of nodes corresponding to a plurality of words;
an inference executing circuitry to execute the inference based on the knowledge graph as a node based on the first input information among the plurality of nodes being an inference start node where inference is started;
an outputting circuitry to output information based on a result of the inference;
a second acquiring circuitry to acquire second input information indicating a user's intention in regard to the result of the inference and including a first word; and
a controlling circuitry to judge whether the result of the inference is appropriate or not based on the information based on the result of the inference and the second input information, and when the result of the inference is inappropriate, determine a node of the first word among the plurality of nodes, add a first node to the knowledge graph, and associate the inference start node and the node of the first word with each other via the first node.

2. The inference device according to claim 1, wherein when the inference start node and the node of the first word have already been associated with each other via the first node and page rank values of the plurality of nodes including the first node are updated, the inference executing circuitry determines a minimum value among a plurality of page rank amounts supplied to the first node from a plurality of second nodes connected via an edge, limits the page rank amount supplied to the first node from each of the plurality of second nodes not to exceed the minimum value, and supplies a page rank amount, not supplied to the first node out of the plurality of page rank amounts, to the inference start node.

3. An update method performed by an inference device, the update method comprising:
acquiring first input information;
executing the inference based on a knowledge graph as a node based on the first input information among the plurality of nodes corresponding to a plurality of words included in the knowledge graph being an inference start node where inference is started;
outputting information based on a result of the inference;
acquiring second input information indicating a user's intention in regard to the result of the inference and including a first word;
judging whether the result of the inference is appropriate or not based on the information based on the result of the inference and the second input information;
when the result of the inference is inappropriate, determining a node of the first word among the plurality of nodes and adding a first node to the knowledge graph; and
associating the inference start node and the node of the first word with each other via the first node.

4. An inference device comprising:
a processor to execute a program; and
a memory to store the program which, when executed by the processor, performs processes of,
acquiring first input information;
executing the inference based on a knowledge graph as a node based on the first input information among the plurality of nodes corresponding to a plurality of words included in the knowledge graph being an inference start node where inference is started;
outputting information based on a result of the inference;
acquiring second input information indicating a user's intention in regard to the result of the inference and including a first word;
judging whether the result of the inference is appropriate or not based on the information based on the result of the inference and the second input information;
when the result of the inference is inappropriate, determining a node of the first word among the plurality of nodes and adding a first node to the knowledge graph; and
associating the inference start node and the node of the first word with each other via the first node.
